(19) United States
(12) Patent Application Publication
(10) Pub. No.: US 2007/0081742 A1
(43) Pub. Date: Apr. 12, 2007

(54) Method of measuring an area of micro-objects of arbitrary shape in scanning electron microscope

(76) Inventors: Dmitriy Yeremin, Dobbs Ferry, NY (US); Arkady Nikitin, Yonkers, NY (US)

Correspondence Address: Ilya Zborovsky, 6 Schoolhouse Way, Dix Hills, NY, 11746, US

(21) Appl. No.: 11/244,356

(22) Filed: Oct. 6, 2005

(51) Int. Cl. G06K 9/36

(52) U.S. Cl. 382/286

(57) ABSTRACT

A method of measuring an area of an micro object has the steps of introducing in a scanning electron microscope an object to be measured, so as to obtain an image of the object; on a print or in a memory; separating a first line from the image; localizing a left edge and a right edge on the first line of the separated image; calculating a distance between the left edge and the right edge of the first line of the object separating further lines and repeating the steps of localization and calculation to obtain the distances between the left edge and the right edge of subsequent lines of the object calculating a total length of the distances; and calculating an area of the object as a product of the total length L and a distance δY between the lines of the image:

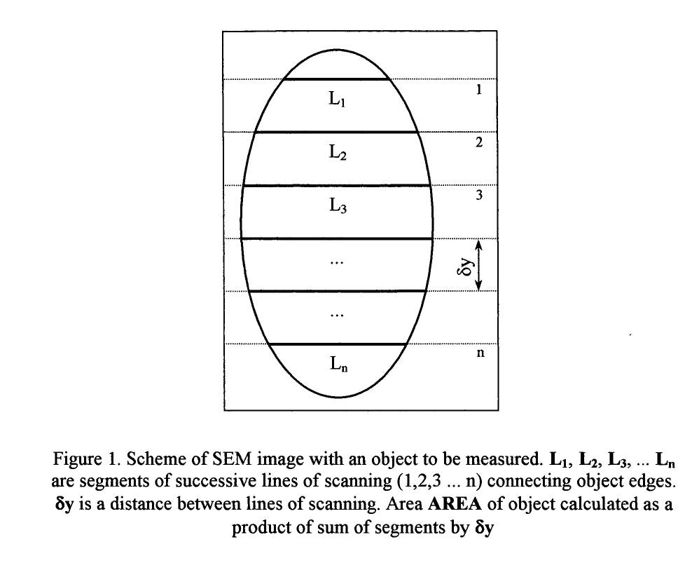

### BACKGROUND OF THE INVENTION

The present invention relates to a method of measuring an area of micro objects of arbitrary shape in scanning electron microscope.

In modern engineering technology and science, in particular in microelectronic technology, it is frequently necessary to measure areas of micro objects of arbitrary shapes. The majority of topological patterns of modern integrated circuits contain rectangles or squares, which are orderly geometrical shape only on layouts. Due to technological reasons, in practice corners of topological figures are usually rounded, and the edges of the rectangles or squares which are straight on the drawing are actually non-straight. This phenomena is known as a line edge roughness. As a result, the actual parameters of the rectangles and squares no longer correspond to the orderly geometrical figure, and it is not possible to determine the actual area of such an object in accordance with formulas of a conventional geometry.

The specifics of such measurements are that the elements of the integrated circuits have sizes of several tenths or hundreds of nanometers. The possibilities of optical microscopes are insufficient to measure objects of such small sizes.

### SUMMARY OF THE INVENTION

Accordingly, it is an object of the present invention to provide a method of measuring an area of micro objects of arbitrary shape in scanning electron microscope, which eliminates the disadvantages of the prior art.

In keeping with these objects and with others which will become apparent hereinafter, one feature of the present invention resides, briefly stated, in a method of measuring an area of an micro object, comprising the steps of introducing in a scanning electron microscope an object to be measured, so as to obtain an image of the objects; separating a first line from the image; localizing a left edge and a right edge on the first line of the separated image; calculating a distance between the left edge and the right edge of the first line of the object L₁; separating further lines and repeating the steps of localization and calculation to obtain the distances between the left edge and the right edge of subsequent lines of the object L₂, L₃ . . . Lₙ; calculating a total length L of the distances:

L=L₁+L₂+L₃ . . . Lₙ wherein n is a number of the lines of the image; and calculating an area of the object as a product of the total length L and a distance δY between the lines of the image:
Area=L·δY.

The present invention also deals with a standard of an area of a micro object, which is produced by the inventive method.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single figure of the drawings is a view illustrating the method in accordance with the present invention.

### DESCRIPTION OF THE PREFERRED EMBODIMENTS

In accordance with the present invention a method is proposed for measuring an area of micro objects of arbitrary form in a scanning electron microscope.

In accordance with the inventive method, an object to be measured is introduced into a chamber of the scanning electron microscope, positioned and oriented on a stage of the microscope, its scanning electron microscope image is focused, a magnification is selected so that the whole object can be located in a field of view of the microscope and the image occupies a greater part of the field of view (50-70%).

The scanning electron microscope image of the object is stored on the print or in the memory of the computer. Then, a line-by-line processing of the stored image is performed. First a first line is separated from the image, a left edge and a right edge on the first line of the separated image are localized a distance between the left edge and the right edge of the first line of the object L₁ is calculated. Then further lines are separated and the steps of localization and calculation are repeated to obtain the distances between the left edge and the right edge of subsequent lines of the object L₂, L₃ . . . Lₙ. A total length L of the distances is calculated:

L=L₁+L₂+L₃ . . . Lₙ wherein n is a number of the lines of the image. Finally an area of the object is calculated as a product of the total length L and a distance δY between the lines of the image:
Area=L·δY.

It should be mentioned that the image of the object can be obtained as the image on a print or in a memory.

For the method of the invention the scanning electron microscope can be used with a digital system of scanning in which the image is stored and represents a two-dimensional digital array of values of video signal S in discrete points which are pixels of a field of view of the microscope S (I, j) where I and j are numbers of the pixels along a line and along a frame correspondingly.

In accordance with the invention the distance between the left and the right edge of the object on the first line can be calculated as a product of a length of the pixel PLₓ along the line and a number of pixels M₁ in this line between the left and the right edges of the object: L₁=PLₓ·M₁. A total number of pixels M is then calculated in the all lines: M=M₁+M₂+M₃+. . . Mₙ, wherein n is a number of lines of the image. The area of the object can be then determined as a product of the total number of pixel M and the length of the pixels along a perpendicular to the line:
Area=M·PL_{y.}

The length of the pixels along the line PLₓ and the length of the pixel along the perpendicular to the line PL_{y} can be determined as a result of a preliminary calibration of the magnification of the microscope along the axes X and Y.

The localization of the left and right edges of the object can be carried out in accordance with the method disclosed in U.S. Pat. No. 6,567,116 B1.

For the calibration of magnification of the microscope along the axis X and Y a NANOCAL™ software can be used as disclosed in Al Sicignano, et al, A novel and robust method for the accurate magnification characterization and calibration of out-of-fab SEM cluster tools Proc. SPIE Vol. 5375, p. 1069-1080, Metrology, Inspection, and Process Control for Microlithography XVIII, 2004

In order to compensate a residual non-linearity of scanning, the calculation of the distance between the left and the right edges of the object on the first line and other lines is carried out as a sum of different values PLₓ of each individual pixel in the corresponding line.

Also, in accordance with the present invention a new standard of an area of objects in submicron and nanometer ranges is proposed. The standard is determined by the method of the present invention including the steps of introducing in a scanning electron microscope an object to be measured, so as to obtain an image of the object; separating a first line from the image; localizing a left edge and a right edge on the first line of the separated image; calculating a distance between the left edge and the right edge of the first line of the object L₁; separating further lines and repeating the steps of localization and calculation to obtain the distances between the left edge and the right edge of subsequent lines of the object L₂, L₃ . . . Lₙ; calculating a total length L of the distances:

L=L₁+L₂+L₃ . . . Lₙ wherein n is a number of the lines of the image; and calculating an area of the object as a product of the total length L and a distance δY between the lines of the image:
Area=L=19 δY.

It will be understood that each of the elements described above, or two or more together, may also find a useful application in other types of methods differing from the types described above.

While the invention has been illustrated and described as embodied in a method of measuring an area of micro objects of arbitrary shape in scanning electron microscope, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of measuring an area of a micro object, comprising the steps of introducing in a scanning electron microscope an object to be measured, so as to obtain an image of the object; separating a first line from the image; localizing a left edge and a right edge on the first line of the separated image; calculating a distance between the left edge and the right edge of the first line of the object L₁; separating further lines and repeating the steps of localization and calculation to obtain the distances between the left edge and the right edge of subsequent lines of the object L₂,L₃ . . . Lₙ; calculating a total length L of the distances:
L=L₁+L₂+L₃ . . . Lₙ wherein n is a number of the lines of the image; and calculating an area of the object as a product of the total length L and a distance δY between the lines of the image:
Area=L·δY.

2. A method as defined in claim 1, wherein said obtaining the image of the object includes obtaining the image on a print or in a memory.

3. A method as defined in claim 1; and further comprising using the scanning electron microscope with a digital system of scanning in which the image is stored and represents a two-dimensional digital array of values of video signal S in discrete points which are pixels of a field of view of the microscope S (I, j) where I and j are numbers of the pixels along a line and along a frame correspondingly.

4. A method as defined in claim 3, wherein the distance between the left and the right edge of the object on the first line is calculated as a product of a length of the pixel PLₓ along the line and a number of pixels M₁ in this line between the left and the right edges of the object: L₁=PLₓ·M₁; calculating a total number of pixels M in the all lines: M=M₁+M₂+M₃+. . . Mₙ, wherein n is a number of lines of the image; and determining the area of the object as a product of the total number of pixel M and the length of the pixels along a perpendicular to the line:
Area=M·PL_{x.}

5. A method as defined in claim 3; and further comprising determining the length of the pixels PLₓ along the line and the length of the pixel PL_{y} along the perpendicular to the line as a result of a preliminary calibration of the magnification of the microscope along the axes X and Y.

6. A method as defined in claim 1; and further comprising performing a localization of the left and right edges of the object in accordance with the method disclosed in U.S. Pat. No. 6,563,116 B1.

7. A method as defined in claim 5; and further comprising using for the calibration of magnification of the microscope along the axis X and Y a NANOCAL™ software disclosed in Al Sicignano, et al, A novel and robust method for the accurate magnification characterization and calibration of out-of-fab SEM cluster tools Proc. SPIE Vol. 5375, p. 1069-1080, Metrology, Inspection, and Process Control for Microlithography XVIII, 2004

8. A method as defined in claim 3; and further comprising in order to compensate a residual non-linearity of scanning, performing the calculation of the distance between the left and the right edges of the object on the first line and other lines as a sum of different values PLₓ of each individual pixel in the corresponding line.

9. A standard of an area of objects in submicron and nanometer ranges, which is determined by the method comprising the steps of introducing in a scanning electron microscope an object to be measured, so as to obtain an image of the object; separating a first line from the image; localizing a left edge and a right edge on the first line of the separated image; calculating a distance between the left edge and the right edge of the first line of the object L₁; separating further lines and repeating the steps of localization and calculation to obtain the distances between the left edge and the right edge of subsequent lines of the object L₂, L₃ . . . Lₙ; calculating a total length L of the distances:
L=L₁+L₂+L₃ . . . Lₙ wherein n is a number of the lines of the image; and calculating an area of the object as a product of the total length L and a distance δY between the lines of the image:
Area=L·δY.
